(19) United States
(12) Patent Application Publication
(10) Pub. No.: US 2005/0215147 A1
(43) Pub. Date: Sep. 29, 2005

(54) Sunscreen fabric and method of making same

(76) Inventors: Charles Ray Masters, Pickens, SC (US); John Phillip Gold, Greenville, SC (US)

Correspondence Address: Sara M. Current, Legal Department, M-495, PO Box 1926, Spartanburg, SC, 29304, US

(21) Appl. No.: 10/810,931

(22) Filed: Mar. 26, 2004

(51) Int. Cl. B32B 27/12; D04B 21/00

(52) U.S. Cl. 442/59; 442/304; 442/312

(57) ABSTRACT

A sunscreen fabric for use in window coverings and the like is described. The fabric has a knit substrate which is coated with a substantially transparent coating which provides the fabric with good stability to enable it to be used as window shades such as roller shades and the like. The fabric also has good resistance to mark-off as well as cup/curl.

### BACKGROUND

Sunscreens such as window shades are often used to provide shielding from the sun's rays and glare caused by those rays. In addition to providing sun screening performance, the shades must also typically be flame resistant (i.e. have FR performance), and have sufficient stiffness to properly hang in the window or from the other structure where it is utilized (e.g. not cup or curl) and in many cases, withstand being rolled up and down by a shade mechanism. To achieve these objectives, shade fabrics are generally made from fabrics that are woven from vinyl-coated fiberglass or polyester yarns, which are then calendered. While providing a level of sun filtration, these prior shade materials have been limited in terms of aesthetics. For one, because the vinyl coating is opaque, the color of the shades is determined by the color of the vinyl coating of the yarns, and thus the available color palette is typically limited. In addition, the fabric construction is limited to conventional open weave patterns. Furthermore, the vinyl coating must be sufficient to prevent the edges of the woven fabric from fraying.

### SUMMARY

The present invention is directed to a sunscreen fabric having virtually unlimited aesthetic potential, which diffuses light better than prior vinyl-coated fiberglass or polyester shade fabrics, and which can be cut and fabricated without fraying or having to use anti-fray sprays prior to cutting.

The sunscreen fabrics include a knit fabric base that can be dyed, printed, or otherwise colored or patterned in a conventional manner. The fabric is coated with a urethane coating that provides it with good stiffness and resistance to undesirable cupping and curling. The fabric also has comparable FR performance as compared with prior shade materials. Furthermore, the fabrics of the invention have a high resistance to mark-off, and do not have the environmental disadvantages associated with the vinyls used in the conventional screen materials.

### BRIEF DESCRIPTION OF THE DRAWINGS

FIG. 1 is a stitch diagram of the fabric described in Example B;

FIG. 2 is a stitch diagram of the fabric described in Example C;

FIG. 3 is a schematic illustration of a process according to the instant invention;

FIGS. 4A and 4B are scanned pieces of fabric;

FIG. 5 is a perspective view of a roller shade; and

FIG. 6 is a scanned piece of fabric.

### DETAILED DESCRIPTION

In the following detailed description of the invention, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

The fabrics of the invention have a knit base fabric which is preferably a warp knit construction, such as a raschel or tricot knit. The fabric is preferably at least a two bar construction, though it may be made from three bars, four bars, etc., depending on the complexity desired for the pattern. The fabric is preferably constructed to have from about 2% to about 25% openness (defined as the amount of open space relative to the total fabric area.) As will be readily appreciated by those of ordinary skill in the art, the level of openness can be selected to tailor the amount of light that it is desired to let pass through, the amount of screening desired, etc. For example, sunscreens designed to be used on windows on the sun-facing side of a building may be designed to be less open, while those for the shady side of a building may be designed to be more open, to enable more natural light to enter the room.

One advantage of the knit fabric construction is that it can be designed to provide a particular aesthetic appearance, and can be constructed to provide different appearances on each of the fabric surfaces. In addition, complex knits such as a jacquard knit construction can be used to provide additional aesthetic characteristics. In addition, it has been found that a greater fabric thickness promotes light absorption, so desirably the yarn size and fabric thickness will be selected to achieve the desired level of absorption.

The knit fabric can be made from any yarn desired. For example, it can be made from natural and/or man-made fibers, including but not limited to polyester, nylon, acetate, rayon, cotton, aramids, olefins (e.g. polypropylene) or the like, or blends or combinations thereof. However, filament polyester is preferred since it has been found to resist UV degradation well. However, other fibers may be utilized provided they are treated to enhance their UV resistance, FR performance, and the like as needed. For example, fibers that have inherent FR characteristics may be used. Where polyester is utilized, FR polyester can be used, or a non-FR polyester can be treated with a conventional FR treatment. In addition, the yarns can be spun or filament, flat or textured yarns, or combinations thereof.

Where desired, the fabric can be dyed to the desired color and shade, such as by a conventional dye process (e.g. jet dyeing, jig dyeing, pad dyeing, range dyeing, etc.) For example, where the knit fabric is polyester, a jet dye process has been found to perform well. Alternatively, the fabric can be knit from yarns that are the color desired for the end fabric, such as solution dyed or yarn dyed yarns. As a further alternative, the fabric can be patterned in addition to or instead of a dye process, such as by printing, embossing, a thermal pattern treatment process, fluid pattern treatment process, or the like, or a combination thereof. For example, in one embodiment of the invention, a black solution dyed yarn is included, to facilitate absorption of the light. The fabric base color can be tailored as well to facilitate achievement of the desired level of absorption.

The fabric can also be treated with additional chemistries if so desired, including but not limited to flame retardants, UV inhibitors or absorbers, antimicrobials, mildecydes, water repellents, soil release chemistries, polychromatic chemistries, odor absorbents, formaldehyde absorbents, or the like. Where such chemistries are utilized, they may be applied separately or simultaneously with dyeing, where a dye process is employed. For example, in one embodiment of the invention, a polyester fabric is jet dyed, with a flame retardant being added into the dye jet during dyeing. Examples of commercially available flame retardants are Flameproof 1503 from Apex Chemical of South Carolina and Pyrozyl EF-9® available from Amitech, Inc. It has been found that exhausting the flame retardant into the fiber in this manner enhances its permanence on the fabric.

The fabric is then desirably coated with a urethane coating, to provide the fabric with additional stiffness. For example, in a preferred form of the invention, the urethane coating used is of the variety described in commonly-assigned U.S. Patent Application for Finish and Process to Create Flame-Retardant Textile That Resists Mark-off” to Arnott, filed Mar. 26, 2004, the subject matter of which is incorporated herein by reference. It has been found that this coating provides good resistance to mark-off, unlike most conventional urethane coatings. (As will be readily appreciated by those of ordinary skill in the art, “mark-off” refers to a visible defect exhibited by a finished or coated fabric when localized contact or bending force is applied (e.g. when it is scratched), resulting in a shattering of the polymer finish or a separation of the polymer finish from the textile, either of which leads to visible scratch lines in the area of localized contact or force.) Specifically, the coating is a combination of a first urethane polymer having an elongation at break of greater than or equal to 500% and a second urethane polymer having an elongation at break of less than 500%, where the ratio of the first urethane polymer to the second urethane polymer is about 10:1 on a solids basis. Preferably, the first and second urethane polymers are either aliphatic polyesters, aliphatic polyethers, or a combination thereof. In a particularly preferred form of the invention, both of the urethane polymers are aliphatic polyesters.

The urethane coating may also include such things as flame retardants, chemistries designed to enhance UV absorption, UV inhibitors, antimicrobials, mildecydes, water repellents, soil release chemistries, polychromatic chemistries, odor absorbents, formaldehyde absorbents or the like. Preferably, the coating is substantially transparent (i.e. doesn't mask the appearance of the fabric to a significant extent), is non-yellowing, and does not contain appreciable amounts of formaldehyde. Where a flame retardant is incorporated, it is preferably incorporated into the molecular backbone of at least one of the urethane polymers.

In a preferred form of the invention, the first urethane polymer has a hardness of between about 5 and about 25 on the Sward Rocker Hardness scale, and the second urethane polymer has a hardness of greater than about 25 on the Sward Rocker Hardness scale. The dry add-on level of the polymer finish is desirably in the range of about 2% to about 15%, and even more preferably in the range of about 3% to about 5%.

Specifically, the urethane coating is desirably one that provides a clear hand builder finish, which is non-yellowing, formaldehyde free and exhibits no mark-off. In addition, the urethane coating desirably can be applied at a low level of add-on so that a pleasing fabric hand is maintained.

The coating can be applied in any conventional manner, such as by pad coating, spray coating, foam coating, knife over roll, printing, kiss coating or the like. The coating is preferably applied as a continuous coating, thought it can be applied discontinuously (e.g. in a pattern) if so desired.

Following coating, the fabric is desirably dried in a conventional manner. For roller and Roman shades, fabrics having a finished weight of about 9 to about 13 oz/sq yd have been found to perform well.

One advantage of the fabrics of the invention are that they are resistant to edge fraying, and do not require the use of anti-fray sprays when they are cut and fabricated. They can therefore be used for interior and exterior window shades (screening) for commercial or domestic use, and can also be provided in custom sized products where they are cut to size in the store (e.g. such as a home improvement store.)

Another advantage is that the coatings of the invention enable the fabric's appearance to be readily visible. In addition, unlike many plastic type coatings, the coating is designed to minimize “mark-off”. Typically, people in the textile industry will test for mark-off by scratching their fingernail across a fabric surface and observing whether a mark is left, or by wadding the fabric and smoothing it back out, observing if light colored marks are left where the fabric was creased. Since the lighter-colored streaks are a result of the variation in light reflectance along the scratched or creased portion, mark-off can be a particular problem on darker colored fabrics that are coated.

While discussed specifically in connection with shades (such as roller shades and Roman shades), it is noted that the fabrics of the invention can also be used to produce other types of window coverings, including but not limited to pleated shades, cellular shades, vertical blinds, awnings, umbrellas, room screens and dividers, and the like. Window coverings made according to the invention can be used in virtually any application, including but not limited to buildings (commercial and residential), vehicles (cars, buses, planes, RVs, trailers, boats, ships, etc.), and the like. In many end uses it will be desirable for the sunscreen fabrics to have FR characteristics. These can be inherent in the fibers selected and used, or may be obtained or supplemented through additional chemical treatments applied prior to, at the same time as, or following coating of the fabric.

### EXAMPLES

### Example A

A conventional bone-colored woven roller screen fabric was obtained.

### Example B

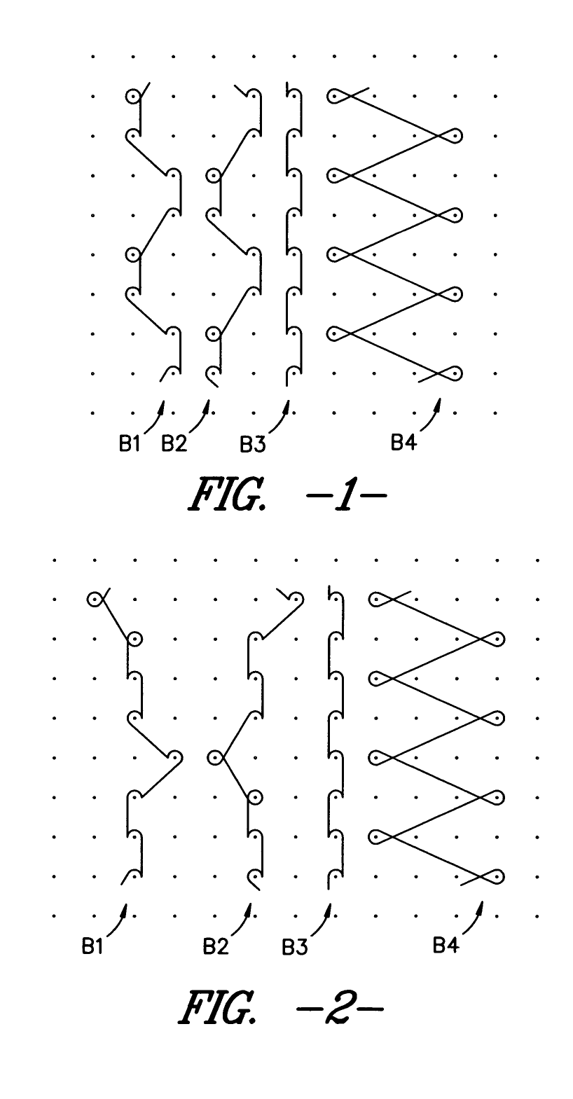

A cream colored fabric according to the invention was prepared as follows. A fabric was knit on a 56 gauge raschel machine using 4 guide bars in the configuration illustrated in FIG. 1. (It is noted that it could also be knit on a tricot single needle bar machine utilizing 4 guide bars.) The machine was loaded with 4 yarn beams with beam #1 containing 1438 ends of 150/34 56WD SD Dacron polyester, beam #2 containing 1438 ends of 150/34 56WD SD Dacron polyester, beam #3 containing 1440 ends of 100/34 56WD SD Dacron polyester and beam #4 containing 1439 ends of 150/34 WD SD Dacron polyester. In this fabric, bar #1 was threaded 1 in, 1 out; bar #2 was threaded 1 in, 1 out; bar #3 and bar #4 were threaded fully.

The fabric was processed on a tenter frame to stabilize it for further processing. The initial tenter pass involved moving the fabric through a bath of water heated to 180 degrees F., then oven drying it at 390 degrees F. at a processing speed of 15 yards per minute. The fabric was then subjected to a conventional jet dye process, using conventional disperse dyes and additives (e.g. defoamer, leveler, etc.) In addition, a minor quantity (0.25% o.w.g.) of UV inhibitor was included, as well as a flame retardant (4% Pyrozyl, available from Amitech of Oxford, N.J.)

The fabric was then again processed on the tenter for the purpose of achieving an equilibrium state of fabric dryness. The second tenter pass involved moving the fabric through a pad of water heated to 110 degrees F., then oven drying at 390 degrees F. at a processing speed of 18 yards per minute.

Once the fabric achieved an equilibrium state of moisture content, a final tenter pass was used to treat the fabric with a padded on aqueous treatment composition containing 87.15% water, 11.08% Sancure® 20025 (available from Noveon from Cleveland, Ohio), and 1.77% Sancure® 1049C (also available from Noveon), by weight. This solution was heated to a level of 90 degrees F. to cure it, and the fabric was oven dried at 390 degrees F. at a processing speed of 18 yards per minute.

### Example C

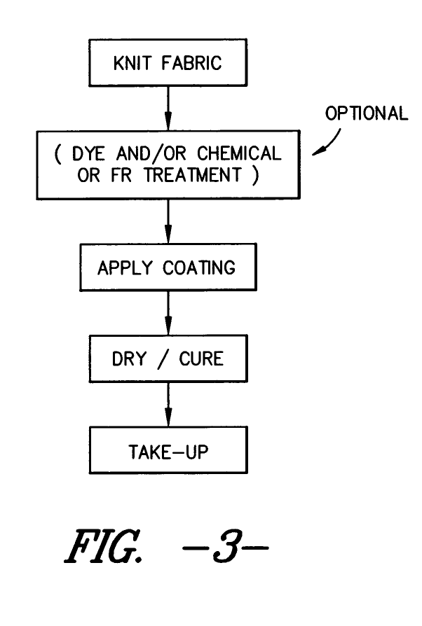

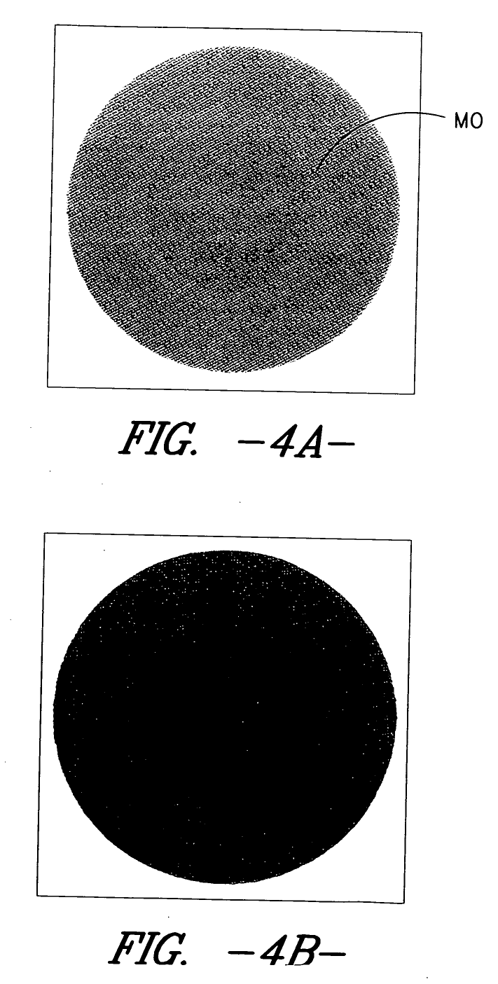

Another cream colored fabric according to the invention was produced in the same manner as Example B, with the exception that the stitch pattern illustrated in FIG. 2 was followed.

### Test Methods

The following tests were performed by Matrix, Inc. of Mesa, Ariz. at its solar laboratory according to ASHRAE Standard 74-1988, “Methods of Measuring Solar Optical Properties of Materials.” As will be readily appreciated by those of ordinary skill in the art, Matrix is the test facility commonly used for testing fabrics of this variety.

Shading Coefficients—The shading coefficients for ¼″ Heat Absorbing, ¼″ Clear Glass, and ⅛″ Clear Glass were tested.

Openness Factor—The amount of open space in the fabric.

Visible Light Transmission (Tv)—The percentage of visible light passing through the fabric (tested from inside the building or structure.)

Solar Absorption (As)—The percentage of solar energy the fabric absorbs. The target will vary depending on where and how the fabric is to be used. As will be appreciated by those of ordinary skill in the art, the solar absorption will be affected by the color of the fabric.

Solar Reflection (Rs)—The percentage of solar energy reflected by the fabric back to the window (i.e. heat that doesn't get back into the room).

Solar Transmission (Ts)—The percentage of solar energy passing through the fabric.

Cup/Curl Test—A 96 inch×74 inch piece of the fabric is cut (long side extending in the widthwise direction.) A sleeve was formed at the bottom and a 5 pound bar was inserted. The top of the fabric was tacked to a wall and the fabric is left under regular indoor environmental conditions. After 24 hours, the distance between the wall and the fabric edges at the position on the edge that is the greatest distance from the wall is measured. To be useful as a roller or Roman shade, the Cup/curl at 96 inches of width should be about 20 mm or less.

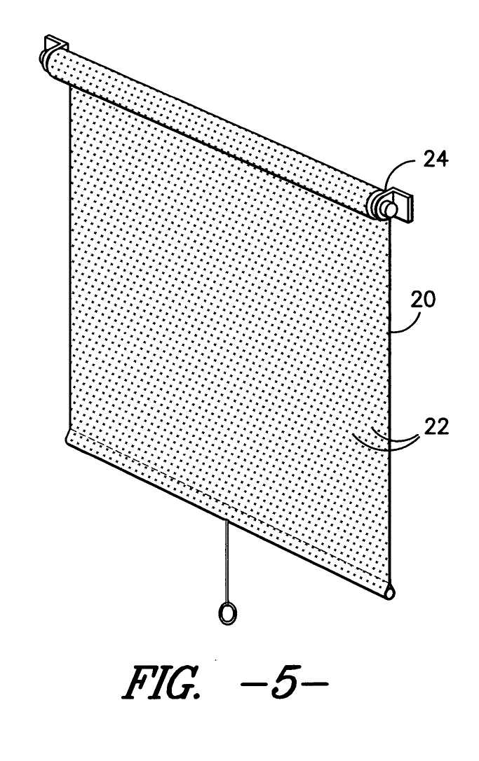

Mark-off—Mark-off was tested using a conventional yarn fray testing apparatus. The method involved taking a 130 mm diameter circular test specimen and installing the test piece of fabric on the turn table with double-sided tape. A blade edge was positioned with a 1.96N weight on the blade, so that it contacts the fabric, and the turntable is rotated two times at 1 rpm. After the test, the surface of the sample is observed and rated between 1 and 5, with a “1” indicating extreme mark-off and an unacceptable fabric. A “5” demonstrates no visible mark-off. A rating of 3.5 or greater would generally be considered to be acceptable for most sunscreen applications. FIG. 4A illustrates a fabric having a “1” rating (extreme mark-off, illustrated at “MO”), while FIG. 4B is a scanned fabric having a 4.5 mark-off rating.

Table of Test Results

| Test | Ex. A | Ex. B | Ex. C |
|---|---|---|---|
| Shade | 0.36 | 0.41 | 0.41 |
| Coefficient- | | | |
| ¼ “heat | | | |
| absorbing glass | | | |
| (%) | | | |
| Shade | 0.41 | 0.51 | 0.5 |
| Coefficient- ¼″ | | | |
| clear glass (%) | | | |
| Shade | 0.42 | 0.53 | 0.51 |
| Coefficient- ⅛″ | | | |
| clear glass (%) | | | |
| Openness | 5 | 5 | 4 |
| Factor (Of) (%) | | | |
| Visible Light | 12 | 17 | 15 |
| Transmission | | | |
| (Tv) (%) | | | |
| Solar | 27 | 26 | 27 |
| Absorption (As) | | | |
| (%) | | | |
| Solar Reflection | 55 | 44 | 45 |
| (Rs) (%) | | | |
| Solar | 18 | 30 | 28 |
| Transmission | | | |
| (Ts) (%) | | | |
| Cup/Curl | N/A | <6 mm over 96 | <6 mm over 96 |
| | | inches | inches |
| Mark-off | 4.0 | 4.0 | 4.0 |

As illustrated, the fabrics of the invention achieved comparable levels of solar performance relative to the conventional material. In addition, by using the knit fabrics described herein, the sunscreens can be made with different appearances on each side if so desired. Also, the size of the hole can be designed to achieve the desired level of openness, without sacrificing stability (as would be the case with the woven shade fabrics.) Furthermore, the sunscreen fabrics made according to the invention are fray resistant, so that they can be readily customized to a desired width without the need for supplemental fray resist mechanisms.

Also, the fabrics also have good Cup/curl resistance, preferably less than about 20 mm, more preferably about 10 mm or less. For example, the fabrics from the examples above demonstrated about 6 mm of Cup/curl.

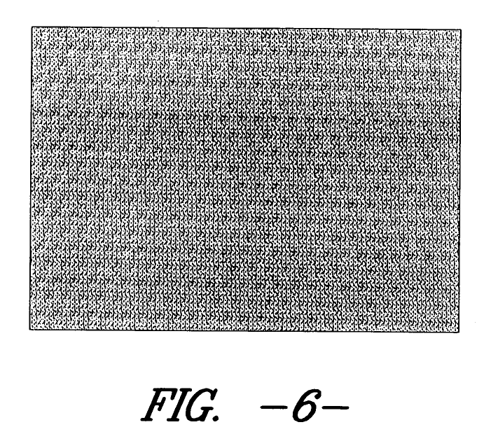

As noted above, the sunscreen fabrics of the invention are desirably secured to a structure so that they can effectively screen sunlight as desired. FIG. 5 illustrates a fabric of the invention secured to a support mechanism 24 to form a roller shade 20. The roller shade 20 is illustrated as having a pattern 22 on its surface. As noted, the pattern can be provided in a variety of manners, such as by forming it into the fabric structure, printing, embossing, a fluid pattern treatment process and/or a thermal pattern treatment process.

As discussed previously, the issue of mark-off is more pronounced on dark colored fabrics than light colored fabrics. While the samples listed in the table above are light colored, additional samples were prepared in the same manner, though they were dyed a dark color prior to application of the polymer coating. In those embodiments of the invention, the mark-off resistance was still greater than 3.5, and in most instances, a 4.5 or greater.

In the specification there has been set forth a preferred embodiment of the invention, and although specific terms are employed, they are used in a generic and descriptive sense only and not for purpose of limitation, the scope of the invention being defined in the claims.

1. A sunscreen fabric comprising:
a warp knit fabric having at least a two bar construction, and a polymer coating applied to said fabric, wherein said polymer coating comprises a urethane polymer and the coated fabric exhibits a cup/curl of less than about 20 mm at 96 inches of width.

2. A fabric according to claim 1, wherein said polymer coating is substantially transparent.

3. A fabric according to claim 1, wherein said fabric has an openness of about 2 to about 25%.

4. A fabric according to claim 1, wherein said fabric has a mark-off resistance of about 3.5 or greater.

5. A fabric according to claim 1, wherein said fabric further comprises a flame retardant.

6. A fabric according to claim 1, wherein said fabric is in the form of a window shade.

7. A sunscreen comprising:
a knit fabric, and
a mechanism for securing said knit fabric to a structure.

8. A sunscreen according to claim 7, wherein said knit fabric has an openness of about 2 to about 25%.

9. A sunscreen according to claim 7, wherein said knit fabric is coated with a polymer, and said coated fabric exhibits a Cup/curl of about 20 mm or less over 96 inches of width.

10. A sunscreen according to claim 7, wherein said knit fabric is coated with a polymer, and said coated fabric exhibits a mark-off resistance of about 3.5 or greater.

11. A sunscreen according to claim 7, wherein said knit fabric is coated with a polymer selected from the group consisting of aliphatic polyesters, aliphatic polyethers, and combinations thereof.

12. A sunscreen according to claim 7, wherein said knit fabric is a warp knit fabric having at least a two bar knit construction.

13. A sunscreen according to claim 7, wherein said knit fabric is a warp knit fabric selected from the group consisting of tricot knit and raschel knit fabrics.

14. A sunscreen according to claim 7, wherein said knit fabric has an openness of about 2 to about 25% and said knit fabric is coated with a polymer, wherein said coated fabric exhibits a Cup/curl of about 20 mm or less over 96 inches of width when tested according to a Cup/curl test, and a mark-off resistance of about 3.5 or greater.

15. A sunscreen according to claim 7, wherein said knit fabric is coated with a substantially transparent polymer coating.

16. A sunscreen according to claim 7, wherein said knit fabric includes a pattern.

17. A sunscreen according to claim 16, wherein said pattern is defined by a printed pattern, an embossed pattern, a thermal pattern or a fluid treatment pattern.

18. A sunscreen according to claim 7, wherein said knit fabric defines first and second surfaces, and the first surface of the fabric has a visual appearance which is different from that of the second surface.

19. A sunscreen according to claim 7, wherein said fabric and mechanism define a sunscreen in a form selected from the group consisting of roller shades, Roman shades, pleated shades, awnings, cellular shades, vertical blinds, umbrellas, room screens, and dividers.

20. A method of making a sunscreen fabric comprising the steps of:
providing a warp knit fabric having at least a two bar construction, and
coating said fabric with a coating comprising a combination of a first urethane polymer having an elongation at break of greater than or equal to 500% and a second urethane polymer having an elongation at break of less than 500%, wherein the ration of the first urethane polymer to said second urethane polymer is about 10:1 on a solids basis.

21. The method according to claim 20, wherein said fabric has an openness of about 2 to about 25%.

22. The method according to claim 20, further comprising the step of treating the fabric with a flame retardant.

23. The method according to claim 20, further comprising the step of dyeing the fabric.

24. The method according to claim 20, further comprising the step of providing the fabric with a pattern by a process selected from the group consisting of printing, thermal modification, and fluid treatment.

25. The method according to claim 20, further comprising the step of securing the fabric to a mechanism for securing the fabric to a structure.
